(19) United States
(12) Patent Application Publication
(10) Pub. No.: US 2007/0111321 A1
(43) Pub. Date: May 17, 2007

(54) Detection of explosives and other species

(75) Inventors: Robert Deans, Grafton, MA (US); Aimee Rose, Brookline, MA (US); Marcus la Grone, Cushing, OK (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Nomadics, Inc., Stillwater, OK (US)

(21) Appl. No.: 11/514,092

(22) Filed: Aug. 31, 2006

Related U.S. Application Data
(60) Provisional application No. 60/712,940, filed on Aug. 31, 2005.

(51) Int. Cl. G01N 21/75

(52) U.S. Cl. 436/166

(57) ABSTRACT

The present invention provides a series of systems, devices, and methods relating to the determination of explosives, such as peroxides or peroxide precursors, and other species. Embodiments of the invention may allow a sample suspected of containing an explosive (e.g., a peroxide) or other species to interact with a reactant, wherein the sample may react and cause light emission from the reactant. Advantages of the present invention may include the simplification of devices for determination of peroxide-based explosives, wherein the devices are portable and, in some cases, disposable. Other advantages may include relative ease of fabrication and operation.

### RELATED APPLICATIONS

This application claims priority under 35 U.S.C. § 119(e) to co-pending U.S. Provisional Application Ser. No. 60/712,940, filed Aug. 31, 2005, the contents of which are incorporated herein by reference.

### FIELD OF THE INVENTION

The present invention relates to systems, devices, and methods for the determination of peroxides, peroxide precursors, explosives, and other species.

### BACKGROUND OF THE INVENTION

The rise in terrorist activities in recent years has caused a greater demand for chemical sensor devices for detecting vapors of explosive materials. For example, peroxide-based explosives such as triacteone triperoxide (TATP) and hexamethylene triperoxide diamine (HMTD) are extremely sensitive to detonation by heat, friction, impact, and electrical discharge. Methods of manufacturing such explosives are widely known and can be carried out with relative ease and, since the starting materials needed to synthesize these materials are readily available, the use of peroxide-based explosives has become increasing popular among terrorists.

Existing methods for the vapor phase detection of such explosive materials typically require solution preparation, long sampling times, and are generally not readily field-deployable. Other methods, such as cavity ringdown spectroscopy, typically require delicate optics setup and high power lasers that are also not generally amenable to in-field use. Furthermore, devices such as these often require an external means for photodetection and signal amplification (e.g., a photomultiplier tube). Such equipment can prove costly to fabricate and operate, and can add bulk to the device.

Accordingly, improved devices and methods are needed.

### SUMMARY OF THE INVENTION

The present invention relates to systems for determining a peroxide or a peroxide precursor, comprising a peroxide-reactive material, a catalyst, a light-emitting material, and a support material, wherein each of the peroxide-reactive material, catalyst, and light-emitting material is in solid form, and a source of energy capable of converting an organic peroxide explosive to hydrogen peroxide.

The present invention also provides methods for making a system for determining a peroxide or a peroxide precursor, comprising forming a fluid mixture comprising a peroxide-reactive material, a catalyst, a light-emitting material, and a support material or support material precursor and solidifying the fluid mixture to produce a solid composition that is emissive in the presence of a peroxide.

Another aspect of the present invention provides methods for determining a peroxide, comprising exposing a solid comprising a peroxide-reactive material to a vapor suspected of containing a peroxide, wherein the peroxide, if present, causes the solid to generate a determinable signal, determining the signal.

Another aspect of the invention provides methods for determining an explosive in an area, comprising distributing a solid on a surface in an area suspected of containing an explosive, determining a chemiluminescence of the solid, and identifying the area as an area containing an explosive.

The present invention also relates to devices comprising an inlet for intake of a vapor sample, a sample cell comprising a solid, peroxide-reactive material constructed and arranged to receive the vapor sample, and a detection mechanism in optical communication with the sample cell.

The present invention also relates to devices for detection of an explosive comprising an inlet for intake of a vapor sample, a sample cell comprising a material reactive with an explosive or a reactant or a decomposition product of the explosive, the sample cell constructed and arranged to receive the vapor sample; and a detection mechanism in optical communication with the sample cell, wherein the detection mechanism is free of an excitation source.

The present invention also provides methods for determination of an organic peroxide explosive comprising exposing a solid sensor material to a vapor suspected of containing an organic peroxide explosive, wherein the organic peroxide explosive, if present, causes the solid sensor material to generate a determinable signal; and determining the signal.

The present invention also provides methods for determination of a peroxide precursor comprising exposing a vapor suspected of containing a peroxide precursor to a conditions sufficient to convert the peroxide precursor, if present, to a peroxide; exposing a solid comprising a peroxide-reactive material to the vapor, wherein the peroxide, if present, causes the solid to generate a determinable signal; and determining the signal.

### BRIEF DESCRIPTION OF THE DRAWINGS

FIG. 1 illustrates examples of peroxide-based explosives, (a) triacteone triperoxide (TATP) and (b) hexamethylene triperoxide diamine (HMTD).

FIG. 2 shows an illustrative system of the invention.

FIG. 3 illustrates, schematically, a system for determining an explosive according to one embodiment of the invention.

### DETAILED DESCRIPTION

The present invention provides a series of systems, devices, and methods relating to the determination of explosives, such as peroxides or peroxide precursors, and other species.

For example, one relatively simple system of the invention allows the user to expose a sample suspected of containing a peroxide (e.g., a peroxide resulting from breakdown of an explosive composition) to an input of a device which moves the sample, via a gas passageway, to a reaction region containing a solid-state reactant, where any peroxide in the sample reacts and causes light emission without the need for an excitation source.

In one set of embodiments, systems of the present invention comprise solid-state peroxide-reactive materials which may interact with a vapor comprising a peroxide (or peroxide precursor) to generate a determinable signal. In some embodiments, the signal is a chemiluminescence of the system. Systems of the present invention may also include components which are capable of activating a peroxide precursor to generate a peroxide, wherein the peroxide reacts with the solid-state peroxide-reactive materials and causes light emission without the need for an excitation source. Advantages of the present invention may include the simplification of devices for determination of peroxide-based explosives, wherein the devices are portable and, in some cases, disposable. Other advantages may include relative ease of fabrication and operation.

One aspect of the present invention provides systems for the determination of peroxides or peroxide precursors, such as organic peroxide explosives. In some cases, the peroxide precursor may be triacteone triperoxide (TATP), hexamethylene triperoxide diamine (HMTD), or mixtures thereof. As used herein, the term “determination” refers to quantitative or qualitative analysis of a species via, for example, sight, spectroscopy, ellipsometry, piezoelectric measurement, immunoassay, electrochemical measurement, and the like. Systems of the invention may comprise a peroxide-reactive material, a catalyst, a light-emitting material, and a support material, wherein each of the peroxide-reactive material, catalyst, and light-emitting material is in solid form. In some embodiments, the peroxide-reactive material may interact (e.g, undergo a chemical reaction) with a peroxide molecule, which may either directly generate an observable signal (e.g., light emission) or may initiate a series of chemical reactions which may lead to the generation of the observable signal. The light-emitting material may, in connection with the interaction of the peroxide-reactive material with a peroxide or peroxide precursor, give rise to the observable signal. In some embodiments, each of the peroxide-reactive material, catalyst, and light-emitting material are supported on the support material. In some embodiments, the peroxide-reactive material, catalyst, and light-emitting material are combined in a homogenous mixture and the mixture is supported on the support material. In some embodiments, the peroxide-reactive material and the light-emitting material may be evenly dispersed throughout the support material. In some embodiments, the peroxide-reactive material and the light-emitting material may be impregnated within the support material. In some embodiments, the peroxide-reactive material and the light-emitting material may be adsorbed onto the support material.

Systems of the present invention may also include one or more components which may be capable of activating a peroxide precursor (e.g., an organic peroxide explosive) to generate a peroxide molecule or peroxide-containing species, which may then interact with the peroxide-reactive material as described herein. The component may be a source of energy which, when applied to the peroxide precursor, is capable of converting the peroxide precursor to a peroxide molecule, such as hydrogen peroxide, for example, or other peroxide-containing species. The source of energy may be thermal, electric, magnetic, optical, acoustic, electromagnetic, mechanical or the like. In some cases, the source of energy may be electromagnetic radiation, such as ultraviolet light or visible light. In some embodiments, the electromagnetic radiation has a wave length of 350 nm or less, or, more preferably, 254 nm or less, or 200 nm or less. In some cases the source of energy may also be thermal energy, wherein the peroxide precursor is exposed to a temperature sufficient to convert the peroxide precursor to a peroxide molecule or peroxide-containing species.

In some embodiments, the systems of the invention may also comprise a component capable of converting a peroxide precursor to a peroxide molecule or peroxide-containing species. The component may be a chemical species, such as an acid, wherein exposure of the peroxide precursor to the acid results in the conversion of the peroxide precursor to a peroxide molecule or peroxide-containing species. Examples of acids suitable for use in the invention include, but are not limited to, sulfuric acid, hydrochloric acid, acetic acid, and the like. In some cases, the acid may be sulfuric acid. Those of ordinary skill in the art would be able to select appropriate acids (e.g., acids having a pH less than 7) for use in the invention.

The system may include other components which may enhance the stability and/or performance of the system. In some embodiments, the system further comprises a catalyst which facilitates the interaction of the peroxide-reactive material with the peroxide (or peroxide precursor) molecule. The catalyst may enhance the performance of the system, resulting in faster generation of signal, increased signal, etc. In some embodiments, the system further comprises an acid, base, or buffer. For example, in some embodiments, it may desired that the mixture have a pH greater than 7 to avoid undesirable reactions in the presence of acid. In some embodiments, the system further comprises a material capable of converting a peroxide precursor to a peroxide. For example, the material may comprise an acid, which may facilitate, for example, degradation of TATP to hydrogen peroxide.

In one embodiment, systems of the invention may comprise an inlet for intake of a vapor sample, a sample cell comprising the peroxide-reactive material, catalyst, and light-emitting material, the sample cell constructed and arranged to receive the vapor sample, and a detection mechanism in optical communication with the sample cell. Systems such as this may be useful in the determination of, for example, peroxides and peroxide precursors. As used herein, a sample cell “constructed and arranged” refers to a sample cell provided in a manner to direct the passage of a vapor sample, such as a vapor comprising a peroxide, from the inlet into the sample cell, such that the vapor sample contacts at least the peroxide-reactive material. “Optical communication” may refer to the ability of the detection mechanism to receive and detect an optical signal (e.g., light emission) from the sample cell.

Systems of the invention may further include a component which may reduce any background signal caused by, for example, excess hydrogen peroxide vapor in a sample (e.g., hydrogen peroxide which has not been generated by a target analyte (e.g., such as a peroxide precursor or organic explosive peroxide). For example, systems of the invention may further comprise an absorbent material for hydrogen peroxide. The system may be constructed and arranged such that a vapor sample comprising both an organic peroxide explosive and excess hydrogen peroxide vapor may be exposed to the absorbent material prior to exposure to a source of energy, acid, and/or the sample cell comprising the peroxide-reactive material as described herein. The absorbent material may reduce the amount of excess hydrogen peroxide vapor from the sample (e.g., “clean” or “scrub” the sample). Upon exposure of the “cleaned” sample to a source of energy or an acid as described herein, the organic peroxide explosive, if present, may then be converted to a peroxide molecule. This “cleaning” process may enhance the selectivity of systems of the invention. Absorbent materials capable of absorbing hydrogen peroxide are known in the art and include various polymeric materials, such as butyl rubber.

Methods for synthesizing systems for determining a peroxide or a peroxide precursor may comprise forming a fluid mixture comprising a peroxide-reactive material, a catalyst, a light-emitting material, and a support material or support material precursor, and solidifying the fluid mixture to produce a solid composition that is emissive in the presence of a peroxide. In certain cases, forming the fluid mixture may comprise providing the support material precursor as a fluid, and dissolving or suspending the peroxide-reactive material, catalyst, and light-emitting material in the fluid support material precursor. In some embodiments, forming the fluid mixture may comprise providing the support material as a solid, and suspending (i.e., immersing) the support material in the fluid mixture.

In a particular embodiment, forming the fluid mixture may comprise dissolving or suspending the peroxide-reactive material, catalyst, light-emitting material, and support material or support material precursor in an auxiliary fluid. In some embodiments, the auxiliary fluid is a solvent, such that forming the fluid mixture comprises dissolving the peroxide-reactive material, catalyst, light-emitting material, and support material or support material precursor in the solvent. Optionally, a catalyst, acid, base, buffer, and/or other additives (e.g., plasticizers, etc.) may be added to the fluid mixture. Solidification of the fluid mixture may comprise, in cases where a solvent is employed as an auxiliary fluid, removal of a solvent by, for example, evaporation or filtration. Solidification of the fluid mixture may also comprise, in cases where the support material precursor is provided as a fluid, conversion of the support material precursor to a support material (e.g., a solid support material).

In some embodiments, methods for synthesizing systems for determining a peroxide or a peroxide precursor as described herein may produce emissive compositions which are chemiluminescent. In one embodiment, the resulting system is a powder. In some embodiments, the system may have a shape or be formed into a shape (for example, by casting, molding, extruding, and the like). In some embodiments, the support material may be a film, a bottle, a sphere, a tube, a strip such as an elongated strip or tape, or the like.

Another aspect of the present invention provides methods for the determination of a peroxide or peroxide precursor. As used herein, a “peroxide precursor” may be a material which may generate a peroxide upon activation, for example, by electromagnetic radiation or an acid. Such methods may comprise exposing a solid comprising a peroxide-reactive material (e.g., according to systems described herein) to a vapor suspected of containing a peroxide, wherein the peroxide, if present, causes the solid to generate a determinable signal (e.g., a light emission), and determining the signal.

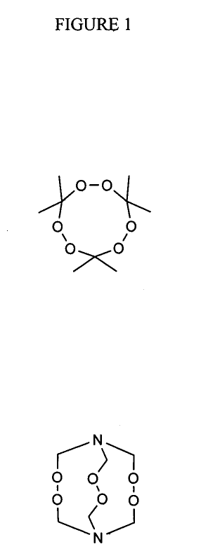

In some embodiments, the peroxide or peroxide precursor may be an organic peroxide explosive. As used herein, an “organic peroxide explosive” includes organic materials comprising one or more peroxide moieties (e.g., —O—O—), as well as any organic material that may be treated or otherwise activated to produce a species containing a peroxide moiety, that may be used as an explosive. In some embodiments, the vapor may comprise peroxide-based explosives (e.g., organic peroxide explosives) such as TATP and HMTD, as shown in FIG. 1. In some cases, TATP may be “activated” or degraded into hydrogen peroxide vapor by exposure to electromagnetic radiation (e.g., ultraviolet light, 254 nm light, etc.) or by exposure to acid to generate hydrogen peroxide vapor, which may then be determined by systems described herein.

Other examples of peroxides and/or peroxide precursors include hydrogen peroxide, urea hydrogen peroxide, sodium pyrophosphate peroxide, histidine peroxide, sodium perborate, and the like.

The present invention also provides methods for determination of an organic peroxide explosive, wherein the method comprises exposure of a solid sensor material to a vapor suspected of containing an organic peroxide explosive. If present, the organic peroxide explosive may cause the solid sensor material to generate a determinable signal, wherein determination of the signal may determine the organic peroxide explosive. In some cases, the solid sensor may comprise a peroxide-reactive material, catalyst, light-emitting material, support material, and/or other components as described herein. In some cases, the method may comprise exposure of the vapor sample to a source of energy wherein the organic peroxide explosive, if present, may be converted to hydrogen peroxide, which, if present, may react with the peroxide-reactive material and cause the solid sensor material to generate the determinable signal. In some embodiments, the method may comprise exposure of the vapor sample to an acid, wherein the organic peroxide explosive, if present, may be converted to hydrogen peroxide which, if present, may react with the peroxide-reactive material and cause the solid sensor material to generate a determinable signal.

The present invention may also comprise methods for determination of peroxide precursor, wherein the method comprises exposing a vapor suspected of containing a peroxide precursor to conditions sufficient to convert the peroxide precursor, if present, to a peroxide species. In some cases, the conditions may comprise exposure to a source of energy, such as electromagnetic radiation. In some cases, the conditions may comprise exposure to an acid. Subsequent exposure of the vapor to a solid comprising a peroxide-reactive material may allow the peroxide, if present, to interact with the solid to generate a determinable signal. Determination of the signal may then determine the peroxide precursor.

In some embodiments, the signal may be an emission of light. In some embodiments, the signal may be generated by chemiluminescence, fluorescence, phosphorescence, and/or combinations thereof. Some embodiments of the invention may generate a chemiluminescent signal arising from a chemiluminescent reaction occurring upon exposure of the system to a vapor comprising a peroxide (or peroxide precursor). The term “chemiluminescence” is known in the art and may refer to the emission of light resulting from a chemical reaction or series of chemical reactions. As used herein, a “chemiluminescent material” or “chemiluminescent solid” may refer to systems of the invention that have the capability to perform a chemiluminescent reaction. In some cases, a peroxide may initiate the chemiluminescent reaction. In some cases, the signal generated by the presence of the peroxide or peroxide precursor may be observable by sight.

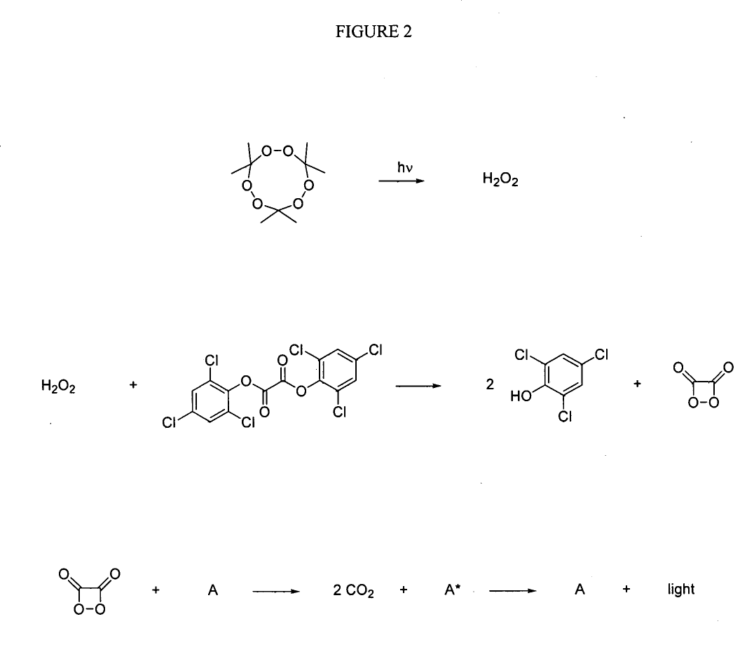

For example, in the illustrative embodiment shown in FIG. 2, a method of the invention may comprise the use of a system comprising bis(2,4,6-trichlorophenyl)oxalate (i.e., as the peroxide-reactive material) and a light-emitting material A (such as anthracene, diphenylanthracene, or 9,10-bis(phenylethynyl)anthracene) supported by a support material, such as corn starch. As shown in FIG. 2A, TATP may be degraded to hydrogen peroxide by exposure to ultraviolet light. The resulting hydrogen peroxide may then react with bis(2,4,6-trichlorophenyl)-oxalate to form 1,2-dioxetanedione. (FIG. 2B) Because 1,2-dioxetanedione is highly strained and reactive, it quickly decomposes to CO₂ in a highly exothermic reaction, transferring energy to the light-emitting material A. Thus, light emission via a chemiluminescent reaction may observed from the light-emitting material A. The light emission may be observed by sight, without need for additional photodetection equipment.

Other light-emitting processes and reactions (e.g., chemiluminescent, fluorescent, or phosphorescent processes) are known in the art and may be incorporated into the present invention. For example, in another illustrative embodiment, a system of the invention may comprise 3-amino-phthalhydrazide (“luminol”) as the peroxide-reactive material, a catalyst (such as copper or iron compounds, or potassium ferricyanide, for example), and a base supported by an appropriate support material. In the presence of a peroxide or peroxide precursor, 3-amino-phthalhydrazide may be converted to an excited state aminophthalate ion, which then relaxes to its ground state through chemiluminescence, emitting a photon in the visible region of the spectrum (λ=425 nm). Those skilled in the art would readily recognize other light-emitting systems which may be incorporated within the scope of the invention.

In another aspect, the present invention also provides a method for determining an explosive in an area, comprising distributing a solid (e.g., a solid-state, chemiluminescent system as described herein) on a surface in an area suspected of containing an explosive. The chemiluminescence of the solid may be determined, thus identifying the area as an area containing an explosive. The area may be a surface of a piece of luggage, a surface of an automobile, an area of land or building where it is suspected that explosives are manufactured, stored, or the like, or any other area that might carry explosives or trace amounts of explosive residue and the user of the invention would like information as to the presence of explosives.

Another aspect of the invention provides devices for the determination (e.g., detection) of explosives. In one embodiment, the device comprises an inlet for intake of a vapor sample (e.g., a vapor containing a peroxide), a sample cell comprising a solid, peroxide-reactive material constructed and arranged to receive the vapor sample, and a detection mechanism in optical communication with the sample cell. In some cases, the device may not require an excitation source associated with the sample cell. In some cases, the detection mechanism may comprise a photodiode. In another embodiment, the device comprises an inlet for intake of a vapor sample, a sample cell comprising a material reactive with an explosive or a reactant or a decomposition product of the explosive, the sample cell constructed and arranged to receive the vapor sample, and a detection mechanism in optical communication with the sample cell, wherein the detection mechanism is free of an excitation source.

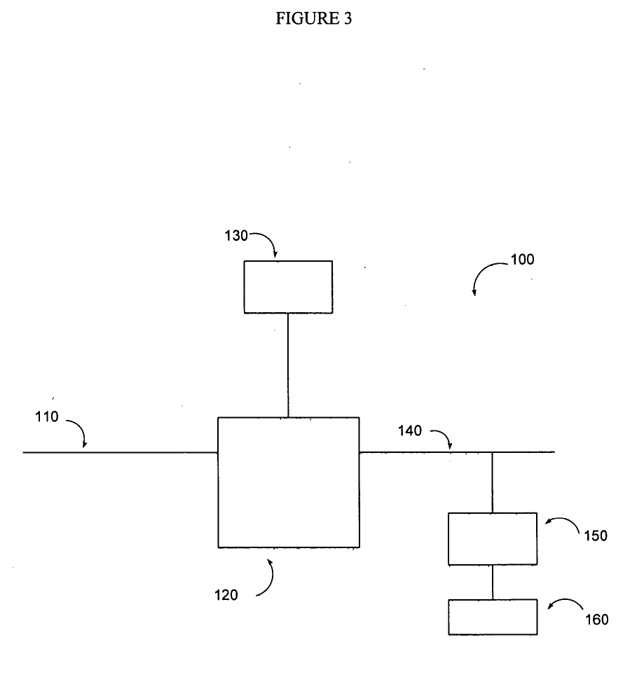

FIG. 3 illustrates, schematically, a system for determining an explosive according to one embodiment of the invention. A device 100 comprises an inlet 110 for intake of a vapor sample. Inlet 110 is connected to sample cell 120, which may comprise systems (e.g., solid-state, chemiluminescent systems) as described herein, such that a vapor sample entering sample cell 120 via inlet 110 may contact the system. Sample cell 120 may be constructed and arranged so that the vapor sample may pass across, over, or through the system, or in some way contact the system. A detector 130 is provided in optical communication with (e.g., connected to) sample cell 120 such that any light emitting from sample cell 120 may be collected, filtered, viewed, and/or stored/displayed by the detector. The detector may comprise a photomultiplier tube, a photodiode, or any apparatus for viewing the light emitted from sample cell 120. The detector may be configured to detect a particular range of emission, such as 400-700 nm (e.g., visible light), or 400-500 nm, or the like. The vapor sample may be removed from sample cell 120 via an outlet 140 connected to sample cell 120. Pump 150 may be connected to outlet 140 to remove the vapor sample from sample cell 120. Also, an out flow meter 160 may be used to regulate pump 150.

The inlet and outlet may be made of materials known in the art, such as polymer, metal, or other materials which may be inert to the vapor sample and/or otherwise suitable for constructing the device. Those of ordinary skill in the art, with the benefit of this disclosure, can readily select appropriate materials and construct a suitable system without undue experimentation.

Devices, systems and methods of the present invention may be advantageous in that they allow for the determination (e.g., detection) of peroxides, peroxide precursors, explosives, and/or other species using a solid-state system. Other detection methods may require delicate optics configurations, high power lasers, complex sampling apparatuses, external means for photodetection and signal amplification (e.g., a photomultiplier tube), and the like. Such equipment can prove costly to fabricate and operate, and can add bulk to the device. Devices of the present invention may eliminate the need for complex sampling and detection equipment, providing simplified, devices amenable to in-field use. In some cases, the devices may be disposable. In some cases, the device may have a strong signal response against a near-zero background (e.g., a high signal-to-noise ratio). Such devices may be easy to fabricate and operate.

The peroxide-reactive material may be any material which can interact (e.g, undergo a chemical reaction) with a peroxide molecule, resulting in the generation an observable signal (e.g., light emission). The interaction may directly generate the signal or may initiate a series of chemical reactions which leads to the generation of the signal. In some embodiments, the peroxide-reactive material is a compound having the formula, 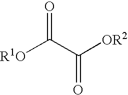
wherein R¹ and R² are independently aryl, substituted aryl, heteroaryl, or substituted aryl. In some embodiments, the aryl or heteroaryl group may be substituted with hydrogen, hydroxy, halide, a carbonyl group, an optionally substituted amine, optionally substituted alkyl, optionally substituted alkoxy, cyano, and/or nitro group. Specific examples include bis(2-nitrophenyl)oxalate, bis(2,4-dinitrophenyl)oxalate, bis(2,6-dichloro-4-nitrophenyl)oxalate, bis(2,4,6-trichlorophenyl)oxalate, bis(3-trifluoromethyl-4-nitrophenyl)oxalate, bis(2-methyl-4,6-dinitrophenyl)oxalate, bis(1,2-dimethyl-4,6-dinitrophenyl)oxalate, bis(2,4-dichlorophenyl)oxalate, bis(2,5-dinitrophenyl)oxalate, bis(2-formyl-4-nitrophenyl)oxalate, bis(pentachlorophenyl)oxalate, bis)1,2-dihydro-2-oxo-1-pyridyl)glyoxal, bis-N-phthalmidyl oxalate, bis(2,4,5-trichloro-6-carbopentoxyphenyl)oxalate, bis(2,4,5-trichloro-6-carbobutoxyphenyl)oxalate, bis(2,4,6-trichlorophenyl)oxalate, bis(2,4,5-trichloro-6-carbopentoxyphenyl)oxalate, bis(2,4,5-trichloro-6-carbobutoxyphenyl)oxalate and phthalimido 3,6,6-trisulfo-2-naphthyl oxalate. Other examples of peroxide-reactive materials include 3-aminophthalhydrazide (luminol), 2,4,5-triphenylimidazole (lophine), 10,10′-dialkyl-9,9′-biacridinium salts (lucigenin), and 9-chlorocarbonyl-10-methylacridinium chloride (rosigenin), and the like. In a particular embodiment, bis(2,4,6-trichlorophenyl)oxalate is the peroxide-reactive material.

In some embodiments, the peroxide-reactive material may be present in an amount of about 1-40 weight %, more preferably 5-20 weight %, even more preferably 10-15 weight % of the solution.

The light-emitting materials used in the present invention may be any compound which has a determinable emission of light (e.g., chemiluminescence, fluorescence, phosphorescence), typically with an emission spectrum between 330-1200 nm. In some embodiments, the emission spectrum is between 400-700 nm. In some embodiments, the presence of a peroxide or peroxide precursor does not affect the ability of the light-emitting material to generate a determinable signal. In some embodiments, the light-emitting material is a fluorescent dye. Light-emitting materials are known in the art and are described in “Fluorescence and Phosphorescence,” by Peter Pringsheim, Interscience Publishers, Inc., New York, N.Y., 1949, and “The Color Index,” Second Edition, Volume 2, The American Association of Textile Chemists and Colorists, 1956. Examples of suitable light-emitting materials include anthracene, benzanthracene, phenanthrene, naphthacene, pentacene, substituted derivatives thereof, and the like. Examples of substituents include phenyl, lower alkyl, halide, cyano, alkoxy, and other substituents which do not interfere with the light-emitting reaction described herein. Additionally, any combination of light-emitting materials may be used to, for example, advantageously alter the wavelength of emitted light, the intensity of emitted light, and the like.

In one embodiment, the light-emitting material is anthracene, diphenylanthracene, or 9,10-bis(phenylethynyl)anthracene. In one embodiment, the light-emitting material is 9,10-bis(phenylethynyl)anthracene.

In some embodiments, the light-emitting material may be a conjugated polymer, such as poly(phenylene-ethynylene), poly(phenylene-vinylene), poly(p-phenylene), polythiophene, substitute derivatives thereof, and the like. The light-emitting capability of such polymers are known in the art, and can be selected to suit a particular application.

In some embodiments, the light-emitting material may be covalently bound to the peroxide-reactive material. In some embodiments, the light-emitting material may be covalently bound to the support material.

In certain embodiments, a peroxide-reactive material may be converted into a light-emitting material by interaction with a peroxide or peroxide precursor. For example, in the presence of a peroxide, peroxide-reactive 3-amino-phthalhydrazide (“luminol”) forms an excited state aminophthalate ion and may be converted to a light-emitting material through the relaxation of the excited state to the ground state, emitting a chemiluminescent signal.

The support material may be any material capable of supporting (e.g., containing) the components (e.g., the peroxide-reactive material, the light-emitting material, etc.) of the systems described herein. For example, the support material may be selected to have a particular surface area wherein the support material may absorb or otherwise contact a sufficient amount of analyte (e.g., organic peroxide explosive) to allow interaction between the analyte and, for example, the peroxide-reactive material. In some embodiments, the support material has a high surface area. In some cases, the support material has a surface area of at least 50 mm², at least 100 mm², at least 200 mm², at least 300 mm², at least 400 mm², or, more preferably, at least 500 mm². In one embodiment, the support material may be filter paper having a surface area of at least 50 mm², or as otherwise described herein.

In some embodiments, the support material may preferably have a low background signal, substantially no background signal, or a background signal which does not substantially interfere with the signal generated by the system in the presence of a peroxide or peroxide precursor. In some cases, the support material may have a preferred pH to prevent undesirable reactions with, for example, an acid. The support material may be soluble, swellable, or otherwise have sufficient permeability in systems of the invention to permit, for example, intercalation of the peroxide-reactive material, the light-emitting material, the catalyst, and other components of the system within the support material. In one embodiment, the support material may be hydrophobic, such that a hydrophobic solution containing the peroxide-reactive material, the light-emitting material, and catalyst may diffuse or permeate the support material. Additionally, the support material may preferably permit efficient contact between the sample (e.g., peroxide or peroxide precursor) to be determined and the peroxide-reactive material. For example, in one embodiment, a vapor comprising a peroxide may permeate the support material to interact with the peroxide-reactive material. The permeability of certain support materials described herein are known in the art, allowing for the selection of a particular support material having a desired diffusion The choice of support material may also affect the intensity and duration of light emission from the system.

Examples of support materials include polymers, copolymers, gels, solid adsorbent materials such as Kim Wipes® and filters. In some embodiments, the support material may be a finely divided powder, particles, molded shapes such as films, bottles, spheres, tubes, strips, tapes, and the like. The support material may be glass wool, glass filter paper, filter paper, nylon filters, and the like. In one embodiment, the support material is a powder. In one embodiment, the support material is a silica. In some embodiments, the system may have a shape or be formed into a shape (for example, by casting, molding, extruding, and the like). In some embodiments, the support material may be a film, a bottle, a sphere, a tube, a strip such as an elongated strip or tape, or the like.

In some embodiments, the support material may be a polymer. Examples include polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, combinations thereof, and the like. In a particular embodiment, the polymer is corn starch.

The combination of support material and solvent may have a desired diffusion rate, controlling the intensity and duration of light emission. The permeability of a particular polymer is known in the art. Examples include polystyrene-poly(divinyl benzene) copolymer and ethylbenzene, poly(vinyl chloride) and ethyl benzoate, and poly(methyl methacrylate) and dimethylphthalate.

The support material may be formed in a variety of ways. The flexibility of the materials may be tuned to fit a desired application by methods known in the art. For example, the addition of plasticisizers, or use of a rubber base, such as silicone. The usual monomeric and preferably oligomeric plasticizers known in the state of the technology can be used within the meaning of the invention, alone or mixed with the polymeric plasticizers. These are, for example, phthalates (phthalic acid esters) such as dioctyl phthalate (DOP), diisononyl phthalate (DINP), diisodecyl phthalate (DIDP), dibutyl phthalate (DBP), diisobutyl phthalate (DIBP), dicyclohexyl phthalate (DCHP), dimethyl phthalate (DMP), diethyl phthalate (DEP), benzyl-butyl phthalate (BBP), butyl-octyl phthalate, butyl-decyl phthalate, dipentyl phthalate, dimethylglycol phthalate, dicapryl phthalate (DCP) and the like; trimellitates, such as, in particular, trimellitic acid esters with (predominantly) linear C6 to C11 alcohols with low volatility and good cold elasticity, acyclic (aliphatic) dicarboxylic acid esters, such as, in particular, esters of adipic acid, such as dioctyl adipate (DOA), diisodecyl adipate (DIDA), especially mixed with phthalates; dibutylsebacate (DBS), dioctyl sebacate (DOS) and esters of azelaic acid, especially mixed with phthalates, dibutyl sebacate; oligomeric plasticizers such as polyesters of adipic, sebacic, azelaic and phthalic acid with diols such as 1,3-butanediol, 1,2-propanediol, 1,4-butanediol, and 1,6-hexanediol, and with triols such as, especially, glycerin and more highly functional alcohols, phosphates (phosphoric acid esters), especially tricresyl phosphate (TCP), triphenyl phosphate (TPP), diphenyl cresyl phosphate (DPCP), diphenyloctyl phosphate (DPOP), tris-(2-ethylhexyl)phosphate (TOP), tris-2-butoxyethyl)phosphate, fatty acid esters, such as, in particular, butyl stearate, methyl and butyl esters of acetylated ricinol fatty acid, triethylene glycol-bis-(2-ethylbutyrate), hydroxycarboxylic acid esters such as, in particular, citric acid esters, tartaric acid esters, lactic acid esters, epoxide plasticizers, such as, in particular, epoxidized fatty acid derivatives, especially triglycerides and monoesters, and the like, such as are known particularly as PVC plasticizers. In this connection, see Rompp Chemie Lexikon, 9th Ed., Vol. 6, 1992, pp. 5017-5020.

The catalyst may be any material which enhances the ability of the system to emit light. In some cases, the catalyst may accelerate the rate of response of the system to a peroxide. For example, in the illustrative embodiment shown in FIG. 2, the addition of sodium salicylate may facilitate the reaction between the oxalic ester and peroxide to form the strained cyclic intermediate, resulting in accelerated signal generation (e.g., light emission). Examples of suitable catalyst may include basic catalysts including amines, hydroxides, alkoxides, carboxylic acid salts and phenolic salts. In some cases, the catalyst may be a carboxylic acid and phenol whose conjugate acid has pKa values between 1-6 in neat water. Some examples include sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, potassium trichlorophenoxide. In a particular embodiment, the catalyst is sodium salicylate.

Solvents which may be used in methods of the invention may include any solvent capable of forming fluid mixture, a suspension, or a homogeneous solution with the components of the system In some cases, the solvent is hydrophobic. Examples may include acyclic or cyclic ethers, such as ethylene glycol ethers, diethyl ether, diamyl ether, diphenyl ether, anisole, tetrahydrofuran, and dioxane, esters such as ethyl acetate, propyl formate, amyl acetate, dialkyl esters of phthalic acid (e.g., dimethyl phthalate, diethyl phthalate, dibutyl phthalate, dioctyl phthalate), methyl formate, triacetin, diethyl oxalate, dioctyl terphthalate, citric acid esters, methyl benzoate, ethyl benzoate, and butyl benzoate, aromatic hydrocarbons, such as benzene, ethyl benzene, butyl benzene, toluene, and xylene, chlorinated hydrocarbons, such as chlorobenzene, o-dichlorobenzene, m-dichlorobenzene, chloroform, carbon tetrachloride, hexachloroethylene, tetrachlorotetrafluoropropane, and the like. In one embodiment, dibutyl phthalate is preferred.

Additionally, other components may be added to systems of the invention. For example, a buffer may added to produce a desired pH of the system. In some embodiments, an acid may be added. In some embodiments, a base may be added. In some cases, the acid and/or base may preferably be inert to the components of the system (e.g., peroxide-reactive material, light-emitting material, catalyst, support material, etc.) Examples of bases which may be used in the invention include inorganic and organic bases, such as sodium hydroxide, potassium hydroxdie, potassium t-butoxide, sodium ethoxide, sodium methoxide, ammonium hydroxide, t-butylammoniuim hydroixde, tripheynl methide, Lewis bases, including pyridine, triethylamine, quinoline, combinations thereof, and the like. Examples of suitable acids include hydrochloric, hydrobromic, sulphuric, nitric, perchloric, fumaric, maleic, phosphoric, glycollic, lactic, salicyclic, succinic, toluene-p-sulphonic, tartaric, acetic, citric, methanesulphonic, formic, benzoic, malonic, naphthalene-2-sulphonic, trifluoroacetic and benzenesulphonic acids, combinations thereof, and the like.

Also, a material capable of decreasing the amount of background peroxide may be optionally included in systems and devices of the invention. For example, enzymes, such as horseradish peroxidase or other catalases, may breakdown background hydrogen peroxide.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A system for determining a peroxide or a peroxide precursor, comprising:
a peroxide-reactive material, a catalyst, a light-emitting material, and a support material, wherein each of the peroxide-reactive material, catalyst, and light-emitting material is in solid form, and
a source of energy capable of converting an organic peroxide explosive to hydrogen peroxide.

2. The system of claim 1, wherein each of the peroxide-reactive material, catalyst, and light-emitting material are supported on the support material.

3. The system of claim 1, wherein the peroxide-reactive material, catalyst, and light-emitting material are combined in a homogenous mixture, the mixture supported on the support material.

4. The system of claim 1, wherein the peroxide-reactive material, catalyst, and light-emitting material are evenly dispersed within the support material.

5. The system of claim 1, wherein the peroxide-reactive material, catalyst, and light-emitting material are adsorbed onto the support material.

6. The system of claim 1, wherein the peroxide-reactive material is a compound having the formula, 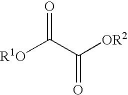
wherein R¹ and R² are independently aryl, substituted aryl, heteroaryl, or substituted aryl.

7. The system of claim 6, wherein the aryl or heteroaryl group may be substituted with hydrogen, hydroxy, halide, a carbonyl group, an optionally substituted amine, optionally substituted alkyl, optionally substituted alkoxy, cyano, and/or nitro group.

8. The system of claim 1, wherein the peroxide-reactive material is bis(2,4,6-trichlorophenyl)oxalate.

9. The system of claim 1, wherein the catalyst enhances the ability of the system to emit light.

10. The system of claim 1, wherein the catalyst is an amine, a hydroxide, an alkoxide, a carboxylic acid salt, or a phenolic salt.

11. The system of claim 1, wherein the catalyst is a carboxylic acid or phenol whose conjugate acid has a pKa value between 1-6 in neat water.

12. The system of claim 1, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide, or combinations thereof.

13. The system of claim 1, wherein the catalyst is sodium salicylate.

14. The system of claim 1, wherein the light-emitting material has an emission spectrum between 330-1200 nm.

15. The system of claim 1, wherein the light-emitting material has an emission spectrum between 400-700 nm.

16. The system of claim 1, wherein the light-emitting material is covalently bonded to the peroxide-reactive material.

17. The system of claim 1, wherein the light-emitting material is covalently bonded to the support material.

18. The system of claim 1, wherein the light-emitting material is a fluorescent dye.

19. The system of claim 1, wherein the light-emitting material is a conjugated polymer.

20. The system of claim 1, wherein the light-emitting material is anthracene, benzanthracene, phenanthrene, naphthacene, pentacene, substituted derivatives thereof, and/or combinations thereof.

21. The system of claim 1, wherein the light-emitting material is anthracene, diphenylanthracene, or 9,10-bis(phenylethynyl)anthracene.

22. The system of claim 1, wherein the light-emitting material is 9,10-bis(phenylethynyl)anthracene.

23. The system of claim 1, wherein the support material is a polymer or copolymer.

24. The system of claim 23, wherein the polymer or copolymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, or combinations thereof.

25. The system of claim 23, wherein the polymer is corn starch.

26. The system of claim 1, wherein the support material is a gel.

27. The system of claim 1, wherein the support material is a solid absorbent material.

28. The system of claim 1, wherein the support may be molded into a shape.

29. The system of claim 28, wherein the shape is a film, bottle, sphere, tube, strip, or tape.

30. The system of claim 1, wherein the support material is silica.

31. The system of claim 1, further comprising a buffer.

32. The system of claim 1, wherein the system exhibits chemiluminescence in the presence of a peroxide.

33. The system of claim 1, further comprising a material capable of converting a peroxide precursor to a peroxide.

34. The system of claim 33, wherein the material comprises an acid.

35. The system of claim 1, comprising:
an inlet for intake of a vapor sample;
a sample cell comprising the peroxide-reactive material, catalyst, and light-emitting material, constructed and arranged to receive the vapor sample; and
and a detection mechanism in optical communication with the sample cell.

36. A method for making a composition for determining a peroxide or a peroxide precursor, comprising:
forming a fluid mixture comprising a peroxide-reactive material, a catalyst, a light-emitting material, and a support material or support material precursor; and
solidifying the fluid mixture to produce a solid composition that is emissive in the presence of a peroxide.

37. The method of claim 36, wherein the emissive composition is chemiluminescent.

38. The method of claim 36, wherein forming the fluid mixture comprises providing the support material precursor as a fluid, and dissolving or suspending the peroxide-reactive material, catalyst, and light-emitting material in the fluid support material precursor.

39. The method of claim 36, wherein forming the fluid mixture comprises providing the support material as a solid, and suspending the support material in the fluid mixture.

40. The method of claim 36, wherein forming the fluid mixture comprises dissolving or suspending the peroxide-reactive material, catalyst, light-emitting material, and support material or support material precursor in an auxiliary fluid.

41. The method of claim 40, wherein the auxiliary fluid is a solvent, and forming the fluid mixture comprises dissolving the peroxide-reactive material, catalyst, light-emitting material, and support material or support material precursor in the solvent.

42. The method of claim 41, wherein the emissive composition is chemiluminescent.

43. The method of claim 42, wherein the solvent is a hydrophobic solvent.

44. The method of claim 42, wherein the solvent is ethylene glycol ethers, diethyl ether, diamyl ether, diphenyl ether, anisole, tetrahydrofuran, dioxane, ethyl acetate, propyl formate, amyl acetate, dimethyl phthalate, diethyl phthalate, dibutyl phthalate, dioctyl phthalate, methyl formate, triacetin, diethyl oxalate, dioctyl terphthalate, citric acid ester, methyl benzoate, ethyl benzoate, butyl benzoate, benzene, ethyl benzene, butyl benzene, toluene, xylene, chlorobenzene, o-dichlorobenzene, m-dichlorobenzene, chloroform, carbon tetrachloride, hexachloroethylene, tetrachlorotetrafluoropropane, or combinations thereof.

45. The method of claim 42, wherein the solvent is dibutyl phthalate.

46. The method of claim 42, wherein the solidifying comprises removal of the solvent.

47. The method of claim 36, wherein the peroxide-reactive material is an oxalate ester having the formula, 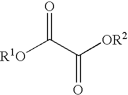
wherein R¹ and R² are independently aryl, substituted aryl, heteroaryl, or substituted aryl.

48. The method of claim 47, wherein the aryl or heteroaryl group may be substituted with hydrogen, hydroxy, halide, a carbonyl group, an optionally substituted amine, optionally substituted alkyl, optionally substituted alkoxy, cyano, and/or nitro group.

49. The method of claim 36, wherein the peroxide-reactive material is bis(2,4,6-trichlorophenyl)oxalate.

50. The method of claim 36, wherein the catalyst enhances the ability of the system to emit light.

51. The method of claim 36, wherein the catalyst is an amine, a hydroxide, an alkoxide, a carboxylic acid salt, or a phenolic salt.

52. The method of claim 36, wherein the catalyst is a carboxylic acid or phenol whose conjugate acid has a pKa value between 1-6 in neat water.

53. The method of claim 36, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide.

54. The method of claim 36, wherein the catalyst is sodium salicylate.

55. The method of claim 36, wherein the light-emitting material has an emission spectrum between 330-1200 nm.

56. The method of claim 36, wherein the light-emitting material has an emission spectrum between 400-700 nm.

57. The method of claim 36, wherein the light-emitting material is covalently bonded to the peroxide-reactive material.

58. The method of claim 36, wherein the light-emitting material is covalently bonded to the support material.

59. The method of claim 36, wherein the light-emitting material is a fluorescent dye.

60. The method of claim 36, wherein the light-emitting material is a conjugated polymer.

61. The method of claim 36, wherein the light-emitting material is anthracene, benzanthracene, phenanthrene, naphthacene, pentacene, substituted derivatives thereof, and/or combinations thereof.

62. The method of claim 36, wherein the light-emitting material is anthracene, diphenylanthracene, or 9,10-bis(phenylethynyl)anthracene.

63. The method of claim 36, wherein the light-emitting material is 9,10-bis(phenylethynyl)anthracene.

64. The method of claim 36, wherein the support material is a polymer or copolymer.

65. The method of claim 64, wherein the polymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), or polybutadiene copolymers.

66. The method of claim 64, wherein the polymer is corn starch.

67. The method of claim 36, wherein the support material is a gel.

68. The method of claim 36, wherein the support may be molded into a shape.

69. The method of claim 68, wherein the shape is a film, bottles, sphere, tube, strip, or tape.

70. The method of claim 36, wherein the support material is silica.

71. The method of claim 36, wherein the peroxide-reactive material, the catalyst, and the light-emitting material are evenly dispersed within the support material.

72. The method of claim 36, further comprising a buffer.

73. The system of claim 36, further comprising a material capable of converting a peroxide precursor to a peroxide.

74. The method of claim 73, wherein the material comprises an acid.

75. A method for determining a peroxide, comprising:
exposing a solid comprising a peroxide-reactive material to a vapor suspected of containing a peroxide, wherein the peroxide, if present, causes the solid to generate a determinable signal; and
determining the signal.

76. The method of claim 75, wherein the peroxide-reactive material is an oxalate ester having the formula, 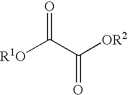
wherein R¹ and R² are independently aryl, substituted aryl, heteroaryl, or substituted aryl.

77. The method of claim 76, wherein the aryl or heteroaryl group may be substituted with hydrogen, hydroxy, halide, a carbonyl group, an optionally substituted amine, optionally substituted alkyl, optionally substituted alkoxy, cyano, and/or nitro group.

78. The method of claim 75, wherein the peroxide-reactive material is bis(2,4,6-trichlorophenyl)oxalate.

79. The method of claim 75, wherein the solid further comprises a light-emitting material.

80. The method of claim 79, wherein the light-emitting material has an emission spectrum between 330-1200 nm.

81. The method of claim 79, wherein the light-emitting material has an emission spectrum between 400-700 nm.

82. The method of claim 79, wherein the light-emitting material is covalently bonded to the peroxide-reactive material.

83. The method of claim 79, wherein the light-emitting material is covalently bonded to the support material.

84. The method of claim 79, wherein the light-emitting material is a fluorescent dye.

85. The method of claim 79, wherein the light-emitting material is a conjugated polymer.

86. The method of claim 79, wherein the light-emitting material is anthracene, benzanthracene, phenanthrene, naphthacene, pentacene, substituted derivatives thereof, and/or combinations thereof.

87. The method of claim 79, wherein the light-emitting material is anthracene, diphenylanthracene, or 9,10-bis(phenylethynyl)anthracene.

88. The method of claim 79, wherein the light-emitting material is 9,10-bis(phenylethynyl)anthracene.

89. The method of claim 75, wherein the solid further comprises a support material.

90. The method of claim 89, wherein the support material is a polymer or copolymer.

91. The method of claim 90, wherein the polymer or copolymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, or combinations thereof.

92. The method of claim 90, wherein the polymer is corn starch.

93. The method of claim 89, wherein the support material is a gel.

94. The method of claim 89, wherein the support material is a solid absorbent material.

95. The method of claim 89, wherein the support may be molded into a shape.

96. The method of claim 95, wherein the shape is a film, bottle, sphere, tube, strip, or tape.

97. The method of claim 89, wherein the support material is silica.

98. The method of claim 75, wherein the solid further comprises a catalyst.

99. The method of claim 98, wherein the catalyst enhances the ability of the system to emit light.

100. The method of claim 98, wherein the catalyst is an amine, a hydroxide, an alkoxide, a carboxylic acid salt, or a phenolic salt.

101. The method of claim 98, wherein the catalyst is a carboxylic acid or phenol whose conjugate acid has a pKa value between 1-6 in neat water.

102. The method of claim 98, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide, or combinations thereof.

103. The method of claim 98, wherein the catalyst is sodium salicylate.

104. The method of claim 75, wherein the solid further comprises a buffer.

105. The method of claim 75 wherein the signal is emission of light.

106. The method of claim 75, wherein the peroxide or peroxide precursor is an explosive.

107. The method of claim 106, wherein the explosive is triacteone triperoxide (TATP).

108. The method of claim 106, wherein the explosive is hexamethylene triperoxide diamine (HMTD).

109. A method for determining an explosive in an area, comprising:
distributing a solid on a surface in an area suspected of containing an explosive;
determining a chemiluminescence of the solid; and
identifying the area as an area containing an explosive.

110. The method of claim 109, wherein the solid comprises a peroxide-reactive material.

111. The method of claim 110, wherein the peroxide-reactive material is an oxalate ester having the formula, 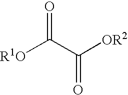
wherein R¹ and R² are independently aryl, substituted aryl, heteroaryl, or substituted aryl.

112. The method of claim 111, wherein the aryl or heteroaryl group may be substituted with hydrogen, hydroxy, halide, a carbonyl group, an optionally substituted amine, optionally substituted alkyl, optionally substituted alkoxy, cyano, and/or nitro group.

113. The method of claim 109, wherein the peroxide-reactive material is bis(2,4,6-trichlorophenyl)oxalate.

114. The method of claim 109, wherein the solid comprises a light-emitting material.

115. The method of claim 114, wherein the light-emitting material has an emission spectrum between 330-1200 nm.

116. The method of claim 114, wherein the light-emitting material has an emission spectrum between 400-700 nm.

117. The method of claim 114, wherein the light-emitting material is covalently bonded to the peroxide-reactive material.

118. The method of claim 114, wherein the light-emitting material is covalently bonded to the support material.

119. The method of claim 114, wherein the light-emitting material is a fluorescent dye.

120. The method of claim 114, wherein the light-emitting material is a conjugated polymer.

121. The method of claim 114, wherein the light-emitting material is anthracene, benzanthracene, phenanthrene, naphthacene, pentacene, substituted derivatives thereof, and/or combinations thereof.

122. The method of claim 114, wherein the light-emitting material is anthracene, diphenylanthracene, or 9,10-bis(phenylethynyl)anthracene.

123. The method of claim 114, wherein the light-emitting material is 9,10-bis(phenylethynyl)anthracene.

124. The method of claim 109, wherein the solid comprises a support material.

125. The method of claim 124, wherein the support material is a polymer or copolymer.

126. The method of claim 125, wherein the polymer or copolymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, or combinations thereof.

127. The method of claim 125, wherein the polymer is corn starch.

128. The method of claim 124, wherein the support material is a gel.

129. The method of claim 124, wherein the support material is a solid absorbent material.

130. The method of claim 124, wherein the support may be molded into a shape.

131. The method of claim 130, wherein the shape is a film, bottle, sphere, tube, strip, or tape.

132. The method of claim 124, wherein the support material is silica.

133. The method of claim 109, wherein the solid comprises a catalyst.

134. The method of claim 133, wherein the catalyst enhances the ability of the system to emit light.

135. The method of claim 133, wherein the catalyst is an amine, a hydroxide, an alkoxide, a carboxylic acid salt, or a phenolic salt.

136. The method of claim 133, wherein the catalyst is a carboxylic acid or phenol whose conjugate acid has a pKa value between 1-6 in neat water.

137. The method of claim 133, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide, or combinations thereof.

138. The method of claim 133, wherein the catalyst is sodium salicylate.

139. The method of claim 109, wherein the solid further comprises a buffer.

140. The method of claim 109, wherein the explosive is triacteone triperoxide (TATP).

141. The method of claim 109, wherein the explosive is hexamethylene triperoxide diamine (HMTD).

142. A device, comprising:
an inlet for intake of a vapor sample,
a sample cell comprising a solid, peroxide-reactive material constructed and arranged to receive the vapor sample,
and a detection mechanism in optical communication with the sample cell.

143. The device of claim 142, wherein the device does not include an excitation source associated with the sample cell.

144. The device of claim 142, wherein the vapor sample contains a peroxide.

145. The device of claim 142, wherein the solid, peroxide-reactive material comprises an oxalate ester having the formula, 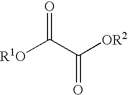
wherein R¹ and R² are independently aryl, substituted aryl, heteroaryl, or substituted aryl.

146. The device of claim 145, wherein the aryl or heteroaryl group may be substituted with hydrogen, hydroxy, halide, a carbonyl group, an optionally substituted amine, optionally substituted alkyl, optionally substituted alkoxy, cyano, and/or nitro group.

147. The device of claim 142, wherein the solid, peroxide-reactive material comprises bis(2,4,6-trichlorophenyl)oxalate.

148. The device of claim 142, wherein the sample cell further comprises a light-emitting material.

149. The device of claim 142, wherein the light-emitting material has an emission spectrum between 330-1200 nm.

150. The device of claim 142, wherein the light-emitting material has an emission spectrum between 400-700 nm.

151. The device of claim 142, wherein the light-emitting material is covalently bonded to the peroxide-reactive material.

152. The device of claim 142, wherein the light-emitting material is covalently bonded to the support material.

153. The device of claim 142, wherein the light-emitting material is a fluorescent dye.

154. The device of claim 142, wherein the light-emitting material is a conjugated polymer.

155. The device of claim 142, wherein the light-emitting material is anthracene, benzanthracene, phenanthrene, naphthacene, pentacene, substituted derivatives thereof, and/or combinations thereof.

156. The device of claim 142, wherein the light-emitting material is anthracene, diphenylanthracene, or 9,10-bis(phenylethynyl)anthracene.

157. The device of claim 142, wherein the light-emitting material is 9,10-bis(phenylethynyl)anthracene.

158. The device of claim 142, wherein the sample cell further comprises a support material.

159. The device of claim 158, wherein the support material is a polymer or copolymer.

160. The device of claim 159, wherein the polymer or copolymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, or combinations thereof.

161. The device of claim 159, wherein the polymer is corn starch.

162. The device of claim 158, wherein the support material is a gel.

163. The device of claim 158, wherein the support material is a solid absorbent material.

164. The device of claim 158, wherein the support may be molded into a shape.

165. The device of claim 164, wherein the shape is a film, bottle, sphere, tube, strip, or tape.

166. The device of claim 158, wherein the support material is silica.

167. The device of claim 142, wherein the sample cell further comprises a catalyst.

168. The device of claim 167, wherein the catalyst enhances the ability of the system to emit light.

169. The device of claim 167, wherein the catalyst is an amine, a hydroxide, an alkoxide, a carboxylic acid salt, or a phenolic salt.

170. The device of claim 167, wherein the catalyst is a carboxylic acid or phenol whose conjugate acid has a pKa value between 1-6 in neat water.

171. The device of claim 167, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide, or combinations thereof.

172. The device of claim 167, wherein the catalyst is sodium salicylate.

173. The device of claim 142, wherein the sample cell further comprises a buffer.

174. The device of claim 142, wherein the detection mechanism is a photodiode.

175. A device for determining an explosive, comprising:
an inlet for intake of a vapor sample;
a sample cell comprising a material reactive with an explosive or a reactant or a decomposition product of the explosive, the sample cell constructed and arranged to receive the vapor sample; and
a detection mechanism in optical communication with the sample cell,
wherein the detection mechanism is free of an excitation source.

176. The device of claim 175, wherein the vapor sample comprises a peroxide.

177. The device of claim 175, wherein the material reactive with the explosive or the reactant or the decomposition product of the explosive is a solid.

178. The device of claim 175, wherein the material is chemiluminescent or is capable of becoming chemiluminescent.

179. The device of claim 175, wherein the material further comprises a light-emitting material.

180. The device of claim 179, wherein the light-emitting material has an emission spectrum between 330-1200 nm.

181. The device of claim 179, wherein the light-emitting material has an emission spectrum between 400-700 nm.

182. The device of claim 179, wherein the light-emitting material is covalently bonded to the peroxide-reactive material.

183. The device of claim 179, wherein the light-emitting material is covalently bonded to the support material.

184. The device of claim 179, wherein the light-emitting material is a fluorescent dye.

185. The device of claim 179, wherein the light-emitting material is a conjugated polymer.

186. The device of claim 179, wherein the light-emitting material is anthracene, benzanthracene, phenanthrene, naphthacene, pentacene, substituted derivatives thereof, and/or combinations thereof.

187. The device of claim 179, wherein the light-emitting material is anthracene, diphenylanthracene, or 9,10-bis(phenylethynyl)anthracene.

188. The device of claim 179, wherein the light-emitting material is 9,10-bis(phenylethynyl)anthracene.

189. The device of claim 175, wherein the material further comprises a support material.

190. The device of claim 189, wherein the support material is a polymer or copolymer.

191. The device of claim 190, wherein the polymer or copolymer is polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, or combinations thereof.

192. The device of claim 190, wherein the polymer is corn starch.

193. The device of claim 189, wherein the support material is a gel.

194. The device of claim 189, wherein the support material is a solid absorbent material.

195. The device of claim 189, wherein the support may be molded into a shape.

196. The device of claim 195, wherein the shape is a film, bottle, sphere, tube, strip, or tape.

197. The device of claim 189, wherein the support material is silica.

198. The device of claim 175, wherein the material further comprises a catalyst.

199. The device of claim 198, wherein the catalyst enhances the ability of the system to emit light.

200. The device of claim 198, wherein the catalyst is an amine, a hydroxide, an alkoxide, a carboxylic acid salt, or a phenolic salt.

201. The device of claim 198, wherein the catalyst is a carboxylic acid or phenol whose conjugate acid has a pKa value between 1-6 in neat water.

202. The device of claim 198, wherein the catalyst is sodium salicylate, tetrabutylammonium salicylate, potassium salicylate, tetrahexylammonium benzoate, benzyltrimethylammonium m-chlorobenzoate, dimagnesium ethylenediamine tetraacetate, tetraethyl ammonium stearate, calcium stearate, magnesium stearate, calcium hydroxide, magnesium hydroxide, lithium stearate, triethylamine, pyridine, piperidine, imidazole, triethylene diamine, or potassium trichlorophenoxide, or combinations thereof.

203. The device of claim 198, wherein the catalyst is sodium salicylate.

204. The device of claim 175, wherein the material further comprises a buffer.

205. A method for determination of an organic peroxide explosive, comprising:
exposing a solid sensor material to a vapor suspected of containing an organic peroxide explosive, wherein the organic peroxide explosive, if present, causes the solid sensor material to generate a determinable signal; and
determining the signal.

206. The method of claim 205, wherein the solid sensor material further comprises a peroxide-reactive material, the method further comprising exposing the vapor to a source of energy wherein the organic peroxide explosive, if present, is converted to hydrogen peroxide which, if present, reacts with the peroxide-reactive material and causes the solid sensor material to generate a determinable signal.

207. The method of claim 206, wherein the source of energy is electromagnetic radiation.

208. The method of claim 207, wherein the electromagnetic radiation has a wavelength of 350 nm or less.

209. The method of claim 207, wherein the electromagnetic radiation has a wavelength of 254 nm or less.

210. The method of claim 207, wherein the electromagnetic radiation has a wavelength of 200 nm or less.

211. The method of claim 205, wherein the solid sensor material further comprises a peroxide-reactive material, the method further comprising exposing the vapor to an acid wherein the organic peroxide explosive, if present, is converted to hydrogen peroxide which, if present, reacts with the peroxide-reactive material and causes the solid sensor material to generate a determinable signal.

212. The method of claim 211, wherein the acid is sulfuric acid.

213. The method of claim 205, wherein the solid sensor material comprises a peroxide-reactive material, a catalyst, a light-emitting material, and a support material.

214. The method of claim 205, wherein the support material has a surface area of at least 50 mm².

215. The method of claim 205, wherein the support material has a surface area of at least 100 mm².

216. The method of claim 205, wherein the support material has a surface area of at least 200 mm².

217. The method of claim 205, wherein the support material has a surface area of at least 300 mm².

218. The method of claim 205, wherein the support material has a surface area of at least 400 mm².

219. The method of claim 205, wherein the support material has a surface area of at least 500 mm².

220. The method of claim 205, wherein the organic peroxide explosive is triacteone triperoxide (TATP), hexamethylene triperoxide diamine (HMTD), or mixtures thereof.

221. The method of claim 205, wherein the organic peroxide explosive is triacteone triperoxide (TATP).

222. The method of claim 205, wherein the organic peroxide explosive is hexamethylene triperoxide diamine (HMTD).

223. A method for determination of a peroxide precursor, comprising:
exposing a vapor suspected of containing a peroxide precursor to conditions sufficient to convert the peroxide precursor, if present, to a peroxide;
exposing a solid comprising a peroxide-reactive material to the vapor, wherein the peroxide, if present, causes the solid to generate a determinable signal; and
determining the signal.

224. The method of claim 223, wherein the conditions comprise exposure to electromagnetic radiation.

225. The method of claim 224, wherein the electromagnetic radiation has a wavelength of 350 nm or less.

226. The method of claim 224, wherein the electromagnetic radiation has a wavelength of 254 nm or less.

227. The method of claim 207, wherein the electromagnetic radiation has a wavelength of 200 nm or less.

228. The method of claim 223, wherein the conditions comprise exposure to an acid.

229. The method of claim 228, wherein the acid is sulfuric acid.

230. The method of claim 223, wherein the solid further comprises a catalyst, a light-emitting material, and a support material.

231. The method of claim 230, wherein the support material has a surface area of at least 50 mm².

232. The method of claim 230, wherein the support material has a surface area of at least 100 mm².

233. The method of claim 230, wherein the support material has a surface area of at least 200 mm².

234. The method of claim 230, wherein the support material has a surface area of at least 300 mm².

235. The method of claim 230, wherein the support material has a surface area of at least 400 mm².

236. The method of claim 230, wherein the support material has a surface area of at least 500 mm².

237. The method of claim 223, wherein the peroxide precursor is triacteone triperoxide (TATP), hexamethylene triperoxide diamine (HMTD), or mixtures thereof.

238. The method of claim 223, wherein the peroxide precursor is triacteone triperoxide (TATP).

239. The method of claim 223, wherein the peroxide precursor is hexamethylene triperoxide diamine (HMTD).

240. The method of claim 1, wherein the source of energy is electromagnetic radiation.

241. The method of claim 240, wherein the electromagnetic radiation has a wavelength of 350 nm or less.

242. The method of claim 240, wherein the electromagnetic radiation has a wavelength of 254 nm or less.

243. The method of claim 240, wherein the electromagnetic radiation has a wavelength of 200 nm or less.
